(19) United States
(12) Patent Application Publication
(10) Pub. No.: US 2017/0342579 A1
(43) Pub. Date: Nov. 30, 2017

(54) PRESSURE RELEASING METHOD OF HIGH-PRESSURE WATER ELECTROLYSIS SYSTEM AND PRESSURE RELEASING METHOD IN WATER ELECTROLYSIS SYSTEM

(71) Applicant: HONDA MOTOR CO., LTD., Tokyo (JP)

(72) Inventors: Hayato DAIMON, Wako (JP); Eiji HARYU, Wako (JP)

(73) Assignee: HONDA MOTOR CO., LTD., Tokyo (JP)

(21) Appl. No.: 15/592,210

(22) Filed: May 11, 2017

(30) Foreign Application Priority Data
May 27, 2016 (JP) 2016-105872

(51) Int. Cl. C25B 15/02; C25B 9/08; C25B 1/12; C25B 13/02; C25B 13/08; H01M 8/0656

(52) U.S. Cl. CPC C25B 15/02; C25B 13/08; H01M 8/0656; C25B 1/12; C25B 13/02; C25B 9/08; H01M 2250/20

(57) ABSTRACT

A pressure releasing method in a water electrolysis system including a water electrolyzer, the pressure releasing method includes operating the water electrolyzer to electrolyze water to produce oxygen with a first pressure on an anode side and hydrogen with a second pressure higher than the first pressure on the cathode side. It is determined whether the water electrolyzer is in a frozen environment when the water electrolysis system stops operating. The cathode side is depressurized without suppling a depressurizing current to the water electrolyzer if it is determined that the water electrolyzer is in the frozen environment, or with suppling the depressurizing current to the water electrolyzer if it is determined that the water electrolyzer is not in the frozen environment.

### CROSS-REFERENCE TO RELATED APPLICATIONS

The present application claims priority under 35 U.S.C. §119 to Japanese Patent Application No. 2016-105872, filed May 27, 2016, entitled “Pressure Releasing Method of High-pressure Water Electrolysis System.” The contents of this application are incorporated herein by reference in their entirety.

### BACKGROUND

### 1. Field

The present disclosure relates to a pressure releasing method of a high-pressure water electrolysis system and a pressure releasing method in a water electrolysis system.

### 2. Description of the Related Art

In general, hydrogen is used as fuel gas for power generation in a fuel cell. Hydrogen is produced by a water electrolysis system that incorporates a water electrolysis device, for example. The water electrolysis device produces hydrogen (and oxygen) by electrolyzing water and thus uses a solid polymer electrolyte membrane (ion exchange membrane).

Electrode catalyst layers are provided on both sides of an electrolyte membrane, and an electrolyte-membrane-electrode structure is thereby configured. Further, power feeders are disposed on both sides of the electrolyte-membrane-electrode structure, and a water electrolysis cell is thereby configured.

Here, in the water electrolysis device in which plural water electrolysis cells are laminated, a voltage is applied to both ends in a laminating direction, and pure water is supplied to an anode power feeder. Thus, on an anode side of the electrolyte-membrane-electrode structure, pure water is decomposed, and hydrogen ions (protons) are generated. The hydrogen ions permeate the solid polymer electrolyte membrane and move to a cathode side and are bonded to electrons to produce hydrogen in a cathode power feeder.

The hydrogen led out from the water electrolysis device is delivered to a gas-liquid separation device, and liquid water is removed. Subsequently, the hydrogen is supplied to a hydrogen purification unit (water adsorption unit), and product hydrogen (dry hydrogen) is obtained. Meanwhile, on the anode side, oxygen generated together with the hydrogen is discharged from the water electrolysis device while accompanying excess water.

Incidentally, the water electrolysis device may be in a low-temperature environment, particularly a frozen environment while an operation is stopped. Accordingly, pure water that stagnates in a water flow path system in the water electrolysis device may freeze and damage the water electrolysis device.

Accordingly, in related art, Japanese Unexamined Patent Application Publication No. 2003-277963 discloses a producing device of high-pressure hydrogen and a producing method of high-pressure hydrogen, for example. In Japanese Unexamined Patent Application Publication No. 2003-277963, in a case of an operation stop, a heat exchanger is used in order to avoid freezing of pure water in the water electrolysis device.

### SUMMARY

According to one aspect of the present invention, a pressure releasing method of a high-pressure water electrolysis system that includes a high-pressure water electrolysis device which electrolyzes supplied water, produces oxygen on an anode side, and produces hydrogen at a higher pressure than the oxygen on a cathode side, the pressure releasing method includes a freezing occurrence assessment step of determining whether or not the high-pressure water electrolysis device is in a frozen environment in a case of a system stop. The pressure releasing method includes an electrolysis depressurization step of performing a depressurization process on the cathode side while a depressurizing current is applied in a case where a determination is made that the frozen environment does not occur. The pressure releasing method includes an electroless depressurization step of performing the depressurization process on the cathode side while the depressurizing current is not applied in a case where a determination is made that the frozen environment occurs.

According to another aspect of the present invention, a pressure releasing method in a water electrolysis system including a water electrolyzer, the pressure releasing method includes operating the water electrolyzer to electrolyze water to produce oxygen with a first pressure on an anode side and hydrogen with a second pressure higher than the first pressure on the cathode side. It is determined whether the water electrolyzer is in a frozen environment when the water electrolysis system stops operating. The cathode side is depressurized without suppling a depressurizing current to the water electrolyzer if it is determined that the water electrolyzer is in the frozen environment, or with suppling the depressurizing current to the water electrolyzer if it is determined that the water electrolyzer is not in the frozen environment.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a schematic configuration explanatory diagram of a high-pressure water electrolysis system that employs a pressure releasing method according to this embodiment of the present disclosure.

FIG. 2 is an explanatory diagram of a housing that configures the high-pressure water electrolysis system.

FIG. 3 is a flowchart for explaining the pressure releasing method.

FIG. 4 is an explanatory diagram of the relationship between a normal depressurization stop pressure and a cross leakage hydrogen amount in the pressure releasing method.

### DESCRIPTION OF THE EMBODIMENTS

The embodiments will now be described with reference to the accompanying drawings, wherein like reference numerals designate corresponding or identical elements throughout the various drawings.

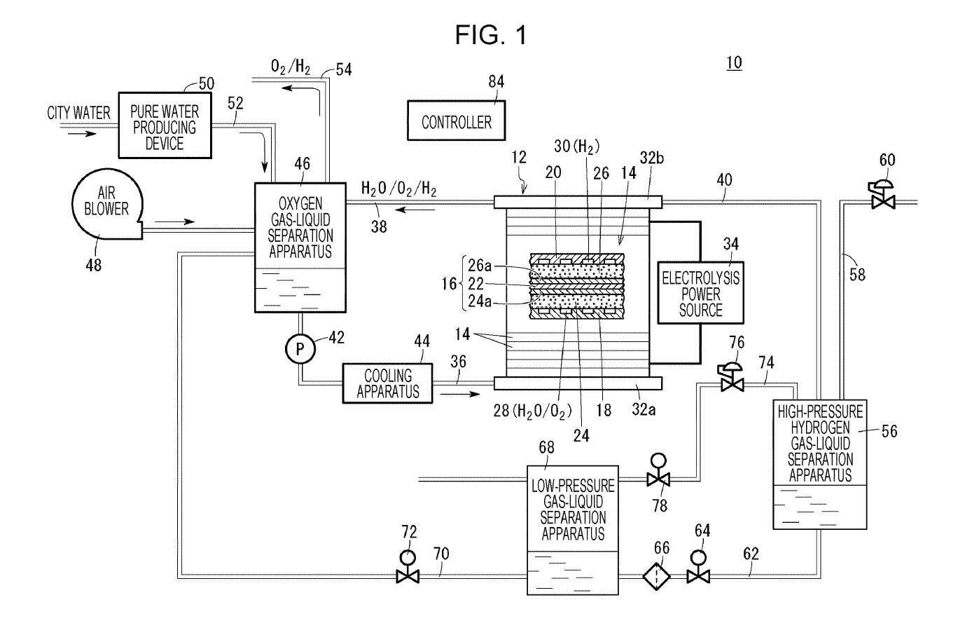

As illustrated in FIG. 1, a high-pressure water electrolysis system 10 according to an embodiment of the present disclosure includes a high-pressure water electrolysis device 12. The high-pressure water electrolysis device 12 electrolyzes water (pure water) and thereby produces oxygen and high-pressure hydrogen (at a higher pressure than an oxygen pressure that is a normal pressure, for example, hydrogen at 1 to 80 MPa).

In the high-pressure water electrolysis device 12, plural water electrolysis cells 14 are laminated. The water electrolysis cell 14 includes a disk-shaped electrolyte-membrane-electrode structure 16 and an anode separator 18 and a cathode separator 20 that are arranged on both sides of the electrolyte-membrane-electrode structure 16, for example.

The electrolyte-membrane-electrode structure 16 includes a solid polymer electrolyte membrane 22 in a general ring shape. The solid polymer electrolyte membrane 22 is interposed between an anode power feeder 24 and a cathode power feeder 26 that are in ring shapes and for electrolysis. The solid polymer electrolyte membrane 22 is configured with a fluorine-based membrane (flat membrane), for example. The anode power feeder 24 and the cathode power feeder 26 are configured with sintered bodies (porous conductors) of spherical atomized titanium powder, for example.

An anode electrode catalyst layer 24a is provided on one surface of the solid polymer electrolyte membrane 22, and a cathode electrode catalyst layer 26a is formed on the other surface of the solid polymer electrolyte membrane 22.

A surface of the anode separator 18 that is opposed to the electrolyte-membrane-electrode structure 16 is supplied with pure water (hereinafter, also simply referred to as water) and is provided with a water flow path 28 through which oxygen generated by a reaction and excess pure water flow. A surface of the cathode separator 20 that is opposed to the electrolyte-membrane-electrode structure 16 is provided with a hydrogen flow path 30 through which hydrogen generated by a reaction flows.

End plates 32a and 32b are disposed at both ends in a laminating direction of the water electrolysis cell 14. An electrolysis power source 34 that is a direct current power source is connected with the high-pressure water electrolysis device 12. A water supply line 36 that communicates with an inlet side (water supply side) of the water flow path 28 is connected with the end plate 32a.

A water discharge line 38 that communicates with an outlet side (water and generated oxygen discharge side) of the water flow path 28 and a hydrogen lead-out line 40 that communicates with the hydrogen flow path 30 (high-pressure hydrogen generating side) are connected with the end plate 32b. Oxygen that is generated by the reaction (and permeating hydrogen) and unreacted water are discharged to the water discharge line 38.

The water supply line 36, on which a circulating water pump 42 and a cooling apparatus 44 are arranged, is connected with a bottom portion of an oxygen gas-liquid separation apparatus 46. An air blower 48 and the water discharge line 38 communicate with an upper portion of the oxygen gas-liquid separation apparatus 46. A pure water supply line 52 that is connected with a pure water producing device 50 and a gas discharge line 54 for discharging oxygen and hydrogen that are separated from the pure water by the oxygen gas-liquid separation apparatus 46 is coupled with the oxygen gas-liquid separation apparatus 46.

The hydrogen lead-out line 40 connects the high-pressure water electrolysis device 12 with a high-pressure hydrogen gas-liquid separation apparatus 56. High-pressure hydrogen from which water is removed by the high-pressure hydrogen gas-liquid separation apparatus 56 is led out to a high-pressure hydrogen supply line 58. The high-pressure hydrogen supply line 58 is provided with a back pressure valve 60 that is set to a predetermined pressure value (for example, 70 MPa).

A water draining line 62 that discharges liquid water separated by the high-pressure hydrogen gas-liquid separation apparatus 56 is connected with a lower portion of the high-pressure hydrogen gas-liquid separation apparatus 56. On the water draining line 62, a first solenoid valve 64 and a drained water depressurization mechanism that applies pressure loss and thereby causes the liquid water of a set water amount to flow through, for example, an orifice 66 are disposed along a flow direction of the liquid water. Instead of the orifice 66, a reducing valve may be used, for example.

The water draining line 62 is connected with a low-pressure gas-liquid separation apparatus 68, which performs gas-liquid separation of the liquid water at a lowered pressure, in a downstream portion of the orifice 66. The low-pressure gas-liquid separation apparatus 68 and the oxygen gas-liquid separation apparatus 46 are connected together by a water returning line 70. A second solenoid valve 72 is disposed on the water returning line 70.

An upper side of the high-pressure hydrogen gas-liquid separation apparatus 56 and an upper side of the low-pressure gas-liquid separation apparatus 68 are connected together by a pressure releasing line 74 that discharges gas (hydrogen) separated in the low-pressure gas-liquid separation apparatus 68. On the pressure releasing line 74, a depressurization mechanism, for example, a reducing valve 76 and a third solenoid valve 78 are disposed along a high-pressure hydrogen flow direction.

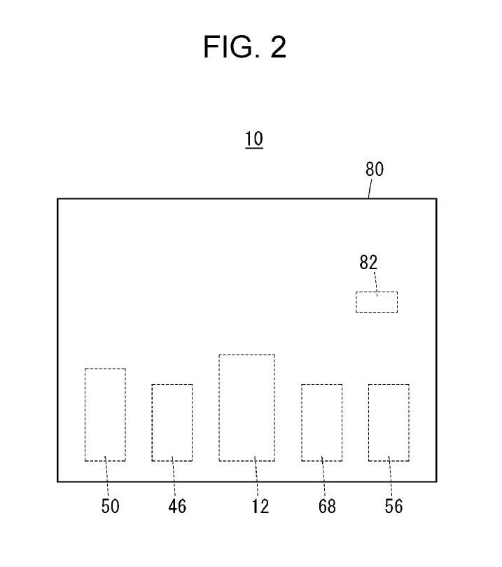

As illustrated in FIG. 2, the high-pressure water electrolysis system 10 includes a housing 80. The housing 80 houses, in addition to the high-pressure water electrolysis device 12, configuration equipment of the high-pressure water electrolysis system 10 such as the oxygen gas-liquid separation apparatus 46, the pure water producing device 50, the high-pressure hydrogen gas-liquid separation apparatus 56, and the low-pressure gas-liquid separation apparatus 68. A temperature sensor 82 that detects an inside housing temperature environment is arranged in the housing 80. Detection results that are obtained by the temperature sensor 82 are transmitted to a controller 84, and the controller 84 performs operation control of the whole high-pressure water electrolysis system 10.

An action of the high-pressure water electrolysis system 10 configured as described above will be described below.

First, in a case of a start operation of the high-pressure water electrolysis system 10, pure water that is generated from city water via the pure water producing device 50 is supplied to the oxygen gas-liquid separation apparatus 46. Then, by work of the circulating water pump 42, the pure water in the oxygen gas-liquid separation apparatus 46 is supplied to the inlet side of the water flow path 28 of the high-pressure water electrolysis device 12 via the water supply line 36. Water moves along an inside of the anode power feeder 24. Meanwhile, a voltage is applied to the high-pressure water electrolysis device 12 via the electrolysis power source 34 that is electrically connected therewith, and the electrolytic current is applied to the high-pressure water electrolysis device 12.

Thus, water is decomposed by electricity in the anode electrode catalyst layer 24a, and hydrogen ions, electrons, and oxygen are generated. The hydrogen ions that are generated by this anodic reaction permeate the solid polymer electrolyte membrane 22, move to the cathode electrode catalyst layer 26a side, and are bonded to electrons. Consequently, hydrogen is obtained.

Accordingly, the hydrogen dynamically flows from an internal portion of the cathode power feeder 26 along the hydrogen flow path 30. The hydrogen is taken out to the hydrogen lead-out line 40 in a state where the hydrogen is maintained at a higher pressure than the water flow path 28.

Meanwhile, on the outlet side of the water flow path 28, the oxygen generated by the reaction, the unreacted water, and the permeated hydrogen dynamically flow, and those mixed fluids are discharged to the water discharge line 38. The unreacted water, oxygen, and hydrogen are introduced to the oxygen gas-liquid separation apparatus 46 and separated. Subsequently, the water is introduced to the water supply line 36 via the circulating water pump 42. The oxygen and hydrogen that are separated from the water are discharged from the gas discharge line 54 to the outside.

Hydrogen generated in the high-pressure water electrolysis device 12 is delivered to the high-pressure hydrogen gas-liquid separation apparatus 56 via the hydrogen lead-out line 40. In the high-pressure hydrogen gas-liquid separation apparatus 56, the liquid water contained in hydrogen is separated from the hydrogen and stored. Meanwhile, the hydrogen is led out to the high-pressure hydrogen supply line 58. The pressure of the hydrogen is raised to a set pressure (for example, 70 MPa) of the back pressure valve 60. Subsequently, the hydrogen is dehumidified by a dehumidifying device or the like, which is not illustrated, becomes dry hydrogen (product hydrogen), and is supplied to a fuel cell electric vehicle or the like.

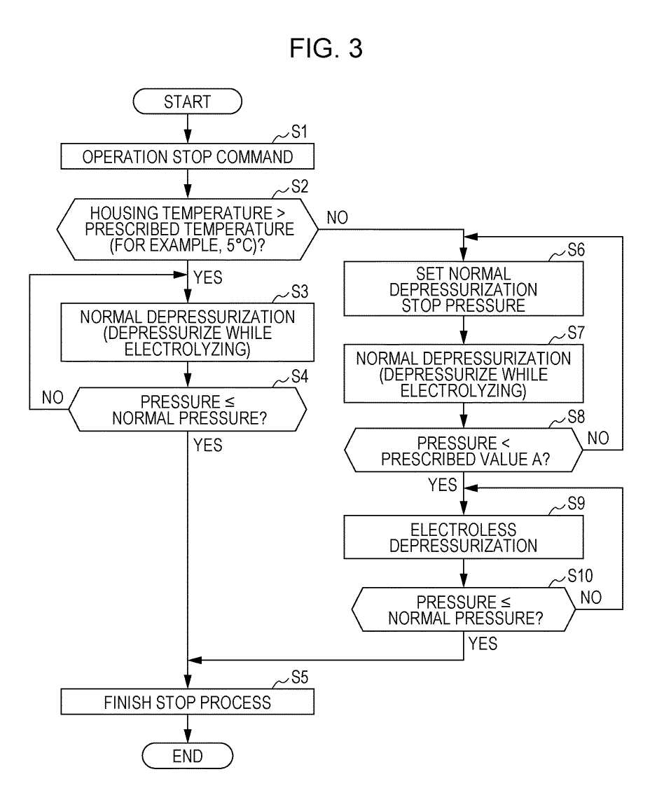

Next, a pressure releasing method of the high-pressure water electrolysis system 10 according to the present embodiment will be described along a flowchart illustrated in FIG. 3.

In a case where an operation stop command of the high-pressure water electrolysis system 10 is performed (step S1), the controller 84 moves to step S2 and determines whether or not the high-pressure water electrolysis system 10 is in a frozen environment in a case of a system stop (freezing occurrence assessment step). Specifically, the temperature in the housing 80 is detected by the temperature sensor 82, and a determination is made whether or not the detected temperature exceeds a prescribed temperature (for example, 5° C.)

In a case where a determination is made that the detected temperature exceeds the prescribed temperature (YES in step S2), that is, a determination is made that the high-pressure water electrolysis system 10 is not in the frozen state in the case of the system stop, the process moves to step S3. In step S3, an electrolysis depressurization process (normal depressurization) of the high-pressure water electrolysis device 12 is started.

Specifically, as illustrated in FIG. 1, because the third solenoid valve 78 is opened, the high-pressure hydrogen that is filled on the cathode side (in a hydrogen flow path system that includes the hydrogen flow path 30) is depressurized while passing from the hydrogen lead-out line 40 through the pressure releasing line 74 and is subsequently discharged to the low-pressure gas-liquid separation apparatus 68.

In this case, an electrolytic current that is lower than the above electrolytic current (hereinafter also referred to as depressurizing current) is applied by the electrolysis power source 34 (electrolysis depressurization process). The depressurizing current is set to a minimum current value by which a membrane pump effect is obtained, for example.

Then, in a case where the hydrogen pressure on the cathode side becomes the same pressure as the pressure (normal pressure) on the anode side (in a water flow path system that includes the water flow path 28) (YES in step S4), voltage application by the electrolysis power source 34 is stopped (step S5). Accordingly, the operation of the high-pressure water electrolysis system 10 is stopped.

On the other hand, in a case where a determination is made that the detected temperature is equal to or lower than the prescribed temperature (NO in step S2), that is, a determination is made that the high-pressure water electrolysis system 10 is in the frozen state in the case of the system stop, the process moves to step S6. In step S6, based on the water flow path system volume in the high-pressure water electrolysis device 12, a pressure (normal depressurization stop pressure) to start electroless depressurization of the high-pressure water electrolysis device 12 is set.

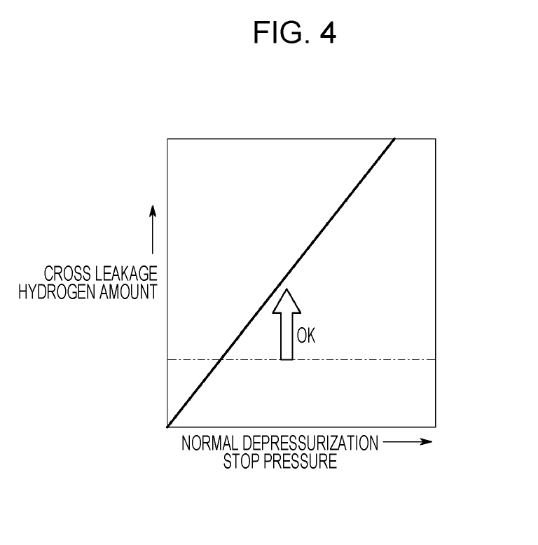

The electroless depressurization (electroless depressurization process) is a process for performing depressurization without performing application of the electrolytic current. In a case of the electroless depressurization, cross leakage (crossover) occurs in which the hydrogen at a high pressure on the cathode side permeates the solid polymer electrolyte membrane 22 and moves to the anode side due to a differential pressure. As illustrated in FIG. 4, the hydrogen amount of the cross leakage is proportional to the pressure to start the electroless depressurization, that is, the normal depressurization stop pressure. The hydrogen that goes through the cross leakage pushes out the pure water (circulating water), which remains on the anode side, from the anode side, and the gas volume is thereby replaced by the water volume.

Thus, the normal depressurization stop pressure is set in order to satisfy the relationships of the volume of the water flow path on the anode side−the hydrogen amount of the cross leakage=the remaining circulating water amount and further the remaining circulating water amount<the remaining water amount that leads to the breakage of the high-pressure water electrolysis device 12 in a case of freezing.

Next, moving to step S7, the electrolysis depressurization process (normal depressurization) of the high-pressure water electrolysis device 12 is started. A determination is made whether or not the electrolysis depressurization process is performed, the pressure on the cathode side thereby lowers, and the pressure on the cathode side becomes lower than a prescribed value A (step S8). The prescribed value A is the normal depressurization stop pressure that is set in step S6, and in a case where a determination is made that the pressure on the cathode side becomes lower than the prescribed value A (YES in step S8), the process moves to step S9.

In step S9, the electroless depressurization process of the high-pressure water electrolysis device 12 is started. Thus, the pressure on the cathode side is likely to lower, and the hydrogen generated on the cathode side is likely to permeate the solid polymer electrolyte membrane 22 and to move to the anode side (cross leakage or crossover). Accordingly, in a case where the gas volume on the anode side increases and the pressure on the cathode side becomes the same pressure as the pressure (normal pressure) on the anode side (YES in step S10), the remaining circulating water amount on the anode side is lower than the remaining water amount that leads to the breakage of the high-pressure water electrolysis device 12 in a case of freezing.

In the present embodiment, in this case, in a case where a determination is made that the high-pressure water electrolysis device 12 is in the frozen environment when the high-pressure water electrolysis device 12 stops, a depressurization process on the cathode side is performed without applying the depressurizing current. Thus, the hydrogen that remains on the cathode side permeates the solid polymer electrolyte membrane 22 and moves to the anode side, and the water that remains in the high-pressure water electrolysis device 12 is pushed out to the outside of the high-pressure water electrolysis device 12 by the permeated hydrogen.

, it is possible to reduce the amount of water that remains in the high-pressure water electrolysis device 12 and to, as much as possible, restrain the high-pressure water electrolysis device 12 from being broken by a simple configuration and control even in a case where freezing occurs in the high-pressure water electrolysis device 12.

Further, in the electroless depressurization step, the pressure to start the electroless depressurization is set based on the water flow path system volume in the high-pressure water electrolysis device 12. Further, in a case where a determination is made that the frozen environment occurs, the electrolysis depressurization process is first performed, and the pressure is thereby lowered to the set pressure (prescribed value A). In this case, after the pressure on the cathode side is lowered to the set pressure, the electroless depressurization process is performed. Accordingly, because the electrolysis depressurization process is performed as much as possible, the durability of the high-pressure water electrolysis device 12 may properly be maintained.

In addition, the high-pressure water electrolysis device 12 is housed in the housing 80 and includes the temperature sensor 82 that detects the temperature environment in the housing 80. Thus, it is possible to accurately perform freezing occurrence assessment at a time after the system stop, based on the detected temperature by the temperature sensor 82.

The present disclosure relates to a pressure releasing method of a high-pressure water electrolysis system that includes a high-pressure water electrolysis device which electrolyzes supplied water, produces oxygen on an anode side, and produces hydrogen at a higher pressure than the oxygen on a cathode side.

This pressure releasing method includes a freezing occurrence assessment step, an electrolysis depressurization step, and an electroless depressurization step. In the freezing occurrence assessment step, a determination is made whether or not a high-pressure water electrolysis device is in a frozen environment in a case of a system stop. In the electrolysis depressurization step, a depressurization process on a cathode side is performed while a depressurizing current is applied in a case where a determination is made that the frozen environment does not occur. Further, in the electroless depressurization step, the depressurization process on the cathode side is performed while the depressurizing current is not applied in a case where a determination is made that the frozen environment occurs.

Further, in the electroless depressurization step, a pressure to start electroless depressurization is preferably set based on a water flow path system volume in the high-pressure water electrolysis device, and in a case where a determination is made that the frozen environment occurs, the electrolysis depressurization process is preferably first performed to lower a pressure to the set pressure. In this case, the electroless depressurization process is preferably performed after the pressure is lowered to the set pressure.

In addition, the high-pressure water electrolysis device is preferably housed in a housing, preferably includes a temperature sensor that detects a temperature environment in the housing, and preferably performs the freezing occurrence assessment step based on a detected temperature by the temperature sensor.

In the techniques of the present disclosure, in a case where a determination is made that the frozen environment occurs, the depressurization process on the cathode side is performed while the depressurizing current is not applied. Thus, hydrogen on the cathode side permeates an electrolyte membrane and moves (performs cross leakage or crossover) to the anode side. Accordingly, water that remains in the high-pressure water electrolysis device is pushed out to an outside of the high-pressure water electrolysis device by the permeated hydrogen.

Accordingly, it is possible to reduce the amount of water that remains in the high-pressure water electrolysis device and to, as much as possible, restrain the high-pressure water electrolysis device from being broken by a simple configuration and control even in a case where freezing occurs in the high-pressure water electrolysis device.

Obviously, numerous modifications and variations of the present invention are possible in light of the above teachings. It is therefore to be understood that within the scope of the appended claims, the invention may be practiced otherwise than as specifically described herein.

What is claimed is:

1. A pressure releasing method of a high-pressure water electrolysis system that includes a high-pressure water electrolysis device which electrolyzes supplied water, produces oxygen on an anode side, and produces hydrogen at a higher pressure than the oxygen on a cathode side, the pressure releasing method comprising:
a freezing occurrence assessment step of determining whether or not the high-pressure water electrolysis device is in a frozen environment in a case of a system stop;
an electrolysis depressurization step of performing a depressurization process on the cathode side while a depressurizing current is applied in a case where a determination is made that the frozen environment does not occur; and
an electroless depressurization step of performing the depressurization process on the cathode side while the depressurizing current is not applied in a case where a determination is made that the frozen environment occurs.

2. The pressure releasing method according to claim 1, wherein in the electroless depressurization step, a pressure to start electroless depressurization is set based on a water flow path system volume in the high-pressure water electrolysis device, and in a case where a determination is made that the frozen environment occurs, the electrolysis depressurization process is first performed to lower a pressure to the set pressure, and the electroless depressurization process is subsequently performed.

3. The pressure releasing method according to claim 1, wherein the high-pressure water electrolysis device is housed in a housing and includes a temperature sensor that detects a temperature environment in the housing, and
the freezing occurrence assessment step is performed based on a detected temperature by the temperature sensor.

4. A pressure releasing method in a water electrolysis system including a water electrolyzer, the pressure releasing method comprising:
operating the water electrolyzer to electrolyze water to produce oxygen with a first pressure on an anode side and hydrogen with a second pressure higher than the first pressure on the cathode side;
determining whether the water electrolyzer is in a frozen environment when the water electrolysis system stops operating; and
depressurizing the cathode side without suppling a depressurizing current to the water electrolyzer if it is determined that the water electrolyzer is in the frozen environment or with suppling the depressurizing current to the water electrolyzer if it is determined that the water electrolyzer is not in the frozen environment.

5. The pressure releasing method according to claim 4, wherein in depressurizing the cathode side without suppling the depressurizing current, a pressure to start electroless depressurization is set based on a water flow path system volume in the water electrolyzer, and if it is determined that the water electrolyzer is in the frozen environment, a electrolysis depressurization process is first performed to lower a pressure to the set pressure, and a process of depressurizing the cathode side without suppling the depressurizing current is subsequently performed.

6. The pressure releasing method according to claim 4, wherein the water electrolyzer is housed in a housing and includes a temperature sensor that detects a temperature environment in the housing, and it is determined whether the water electrolyzer is in the frozen environment on a detected temperature by the temperature sensor.

7. The pressure releasing method according to claim 4, wherein the water electrolyzer is a high-pressure water electrolyzer.

8. The pressure releasing method according to claim 4, wherein an inside of the water electrolyzer freezes in the frozen environment.
